(19) United States
(12) Patent Application Publication
(10) Pub. No.: US 2025/0278259 A1
(43) Pub. Date: Sep. 4, 2025

(54) SYSTEM AND METHOD FOR MANAGING DEVICE UPDATE IN VEHICLE SYSTEM

(71) Applicant: WOVEN BY TOYOTA, INC., Tokyo (JP)

(72) Inventors: Brian CARNES, Palo Alto, CA (US); Sean Norris, Palo Alto, CA (US); Jonathan Thambidurai, Palo Alto, CA (US)

(73) Assignee: WOVEN BY TOYOTA, INC., Tokyo (JP)

(21) Appl. No.: 18/591,618

(22) Filed: Feb. 29, 2024

(51) Int. Cl. G06F 8/65

(52) U.S. Cl. CPC G06F 8/65

(57) ABSTRACT

Provided are a method, a system and a device for managing one or more updates for one or more devices in a vehicle system. According to embodiments, the method may be implemented by at least one processor of a system and may include: obtaining information associated with the update; generating a message including information of the update; and configuring deployment of the update, wherein the update comprises one of: a temporary update and a non-temporary update.

### TECHNICAL FIELD

Systems and methods consistent with example embodiments of the present disclosure relate to vehicle systems, and more particularly, to managing one or more updates of one or more devices in one or more vehicle systems.

### BACKGROUND

Modern vehicles are equipped with a diverse range of devices that form an interconnected vehicle system. These devices include, but are not limited to, electronic control units (ECUs), infotainment systems, sensors, actuators, telematics units, and communication modules. These devices interoperate to provide essential functions such as propulsion, safety, entertainment, connectivity, advanced driver assistance, and the like. In order to ensure optimal performance, safety, and user experiences, as well as to maintain functionality, security, and compatibility with other systems, it is crucial to regularly and timely update the software and firmware of the devices of the vehicle systems. However, with the advancement of vehicle technology and the introduction of complex features, the management of device updates has become increasingly complex and cumbersome.

One of the primary factors which leads to the difficulty in handling device updates is the continuous advancement in vehicle features, which leads to the continuous and significant increment of number and variant of devices in the vehicle system, ranging from traditional features like in-vehicle infotainment system to advanced new features like Internet of Things (IoT) features (e.g., Vehicle-to-Everything (V2X), etc.).

Further, the advancements in software technologies, such as virtualization and containerization, have revolutionized the deployment and management of devices in automotive industry, allowing various devices in vehicle systems (such as Electronic Control Unit (ECU), etc.) to be deployed in software form. Consequently, the number of software components within a vehicle system has continuously and significantly increased. The ever-increasing number of software components in vehicle systems exacerbates the challenge of managing updates, making it a time-consuming and error-prone process.

In this regard, systems and methods for handling device updates in vehicle systems in the related arts are inadequate in effectively addressing the complexities and challenges, due to at least the following reasons.

Firstly, systems in the related art lack of centralize management approach for handling device updates. For instance, in a traditional vehicle system, device updates are typically performed on an individual basis and requiring manual intervention for each device (e.g., users need to send the vehicle and/or the associated devices to the vehicle manufacturer for updates, technicians need to physically visit the devices to perform update thereon, etc.). This approach is time-consuming, error-prone, and inefficient, particularly in scenarios where multiple devices within the vehicle system require simultaneous updates.

Further, systems in the related art often lack standardized and streamlined update processes. Each device may have its own unique update mechanism, requiring separate tools, procedures, and protocols. This fragmentation in update processes leads to inconsistencies, compatibility issues, and challenges in coordinating updates across different devices within the vehicle system.

Moreover, systems in the related art are unable to provide efficient and effective coordination among users in managing device updates. Specifically, complex features in vehicle-related systems often involve multiple users and stakeholders, and thus coordinating and managing device updates across various users can become arduous, especially when different users have different preferences, requirements, or usage patterns. Ensuring that all users have access to the latest updates and that updates do not interfere with each other's workflows or preferences presents a significant challenge. Accordingly, the process of updating a device, such as updating an operating system (OS) or firmware of the device may be complex, particularly when the update (e.g., updated OS, updated firmware, etc.) is provided by a user/party different from the user who is managing the device.

In addition, systems in the related art are unable to effectively handle different types of updates. Amongst others, temporary updates, which are often required for specific operations or scenarios, can be particularly challenging to manage. For instance, whenever an update or a change on the device is temporarily required, the update/change may be made on the root software file (e.g., root OS image file, etc.). Accordingly, the root system image file may be drifted from a known point and it may be time consuming and complicated to restore the image file to the original state after the temporary update is no longer required.

In view of at least the above, there is a need to provide an improved system, method, device, and the like, to manage device updates in vehicle systems.

### SUMMARY

Example embodiments consistent with the present disclosure provide methods, systems, and apparatuses for effectively and efficiently managing one or more updates of one or more devices in one or more vehicle systems.

According to embodiments, a method for managing an update of a device in a vehicle system is provided. The method may be may be implemented by at least one processor of a system, and may include: obtaining information associated with the update; generating a message including information of the update; and configuring deployment of the update, wherein the update may include one of: a temporary update and a non-temporary update. The software file may include an operating system (OS) file.

According to embodiments, the obtaining the information associated with the update may include obtaining the information from at least one of: a user equipment, a build system, and a database. Further, the configuring the deployment of the update may include providing the message to the device via Over-the-Air (OTA) communication to cause the device to configure the deployment of the update based on the message.

According to embodiments, the device may include a remote device located at a geographical location different from the system. Further, the update may be created by a first user located at a first geographical location. The information associated with the update may be obtained from a second user located at a second geographical location, and the first geographical location may be different from the second geographical location.

According to embodiments, the update may include a temporary update on a software file in the device. The device may include a lower layer including the software file, and the configuring the deployment of the update may include providing the message to the device to cause the device to: obtain an updated software file from a database; create an upper layer comprises a software file based on the lower layer and the software file included therein; replace the software file in the upper layer with the updated software file; and remove the updated software file in the upper layer after a period of time.

According to embodiments, the update may include a non-temporary update on the software file in the device, the device may include a first partition and a second partition. The first partition and the second partition may include the software file, and the configuring the deployment of the update may include providing the message to the device to cause the device to: obtain an updated software file from a database; replace the software file in one of the first partition and the second partition with the updated software file; configure the partition with the updated software file as primary partition; and reboot the device to execute the updated software file as primary software.

According to embodiments, a system for managing an update of a device in a vehicle system is provided. The system may include: a memory storage storing computer-executable instructions; and at least one processor communicatively coupled to the memory storage, wherein the at least one processor may be configured to execute the instructions to: obtain information associated with the update; generate a message including information of the update; and configure deployment of the update, wherein the update may include one of: a temporary update and a non-temporary update. The software file may include an operating system (OS) file.

According to embodiments, the at least one processor may be configured to execute the instructions to obtain the information associated with the update by: obtaining the information from at least one of: a user equipment, a build system, and a database. Further, the at least one processor may be configured to execute the instructions to configure the deployment of the update by: providing the message to the device via Over-the-Air (OTA) communication to cause the device to configure the deployment of the update based on the message.

According to embodiments, the device may include a remote device located at a geographical location different from the system. Further, the update may be created by a first user located at a first geographical location. The information associated with the update may be obtained from a second user located at a second geographical location, and the first geographical location may be different from the second geographical location.

According to embodiments, the update may include an temporary update on a software file in the device, the device may include a lower layer including the software file, and the at least one processor may be configured to execute the instructions to configure the deployment of the update by providing the message to the device to cause the device to: obtain an updated software file from a database; create an upper layer including a software file based on the lower layer and the software file included therein; replace the software file in the upper layer with the updated software file; and remove the updated software file in the upper layer after a period of time.

According to embodiments, the update may include a non-temporary update on the software file in the device, the device may include a first partition and a second partition, the first partition and the second partition may include the software file, and the at least one processor may be configured to execute the instructions to configure the deployment of the update by providing the message to the device to cause the device to: obtain an updated software file from a database; replace the software file in one of the first partition and the second partition with the updated software file; configure the partition with the updated software file as primary partition; and reboot the device to execute the updated software file as primary software.

According to embodiments, a non-transitory computer-readable recording medium may be provided. The non-transitory computer-readable recording medium may have recorded thereon instructions executable by at least one processor of a system to cause the processor to perform a method for managing an update of a device in a vehicle system, including: obtaining information associated with the update; generating a message including information of the update; and configuring deployment of the update. The update may include one of: a temporary update and a non-temporary update.

According to embodiments, the non-transitory computer-readable recording medium may have recorded thereon instructions executable by the least one processor to perform the method, wherein the obtaining the information associated with the update may include obtaining the information from at least one of: a user equipment, a build system, and a database. Further, the non-transitory computer-readable recording medium may have recorded thereon instructions executable by the least one processor to perform the method, wherein the configuring the deployment of the update may include: providing the message to the device via Over-the-Air (OTA) communication to cause the device to configure the deployment of the update based on the message. Furthermore, the non-transitory computer-readable recording medium may have recorded thereon instructions executable by the least one processor to perform the method, wherein the device may include a remote device located at a geographical location different from the system.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example system architecture for managing one or more updates of one or more devices in a vehicle system, according to one or more embodiments;

FIG. 2 illustrates a block diagram of example components of a device management system, according to one or more embodiments;

FIG. 3 illustrates a flow diagram of an example method for managing one or more updates for one or more devices in a vehicle system, according to one or more embodiments;

FIG. 4 illustrates a block diagram of an example system configuration for providing update delivery, according to one or more embodiments;

FIG. 5A illustrates a block diagram of a first configuration of an example use case for deploying a device update, according to one or more embodiments;

FIG. 5B illustrates a block diagram of a second configuration of the example use case for deploying the device update, according to one or more embodiments; and

FIG. 6 illustrates a block diagram of a configuration of an example use case for deploying a temporary device update, according to one or more embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

In addition, the term “vehicle” or the like, as used herein, may refer to any motorized and/or mechanical machine which may carry or transport people and/or cargo, such as: a car, a truck, a motorcycle, a bus, a bicycle, a mobility scooter, and the like.

Example embodiments consistent with the present disclosure provide methods, systems, and apparatuses for managing one or more updates of one or more devices in one or more vehicle systems.

Specifically, example embodiments provide a device management system (and methods for utilizing the same) which may provide centralized management of device updates in a vehicle system. Accordingly, devices in the vehicle system, such as remote devices, may be effectively and efficiently updated without manual intervention or physical visit to the site.

Further, the device management system of example embodiments may provide standardized and streamlined update processes, thereby ensuring consistency and compatibility in device updates across different devices in the vehicle system. Furthermore, the device management system of example embodiments may receive inputs from multiple users and may manage the device updates based on the user inputs, thereby provide efficient and effective coordination among users in managing device updates. Further still, the device management system of example embodiments may provide efficient and effective updates on different types of updates, and ensure revisable update.

Ultimately, example embodiments of the present disclosure enable efficient and effective management of updates for significant amount of devices, thereby solving the problems in the related art systems as described above.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

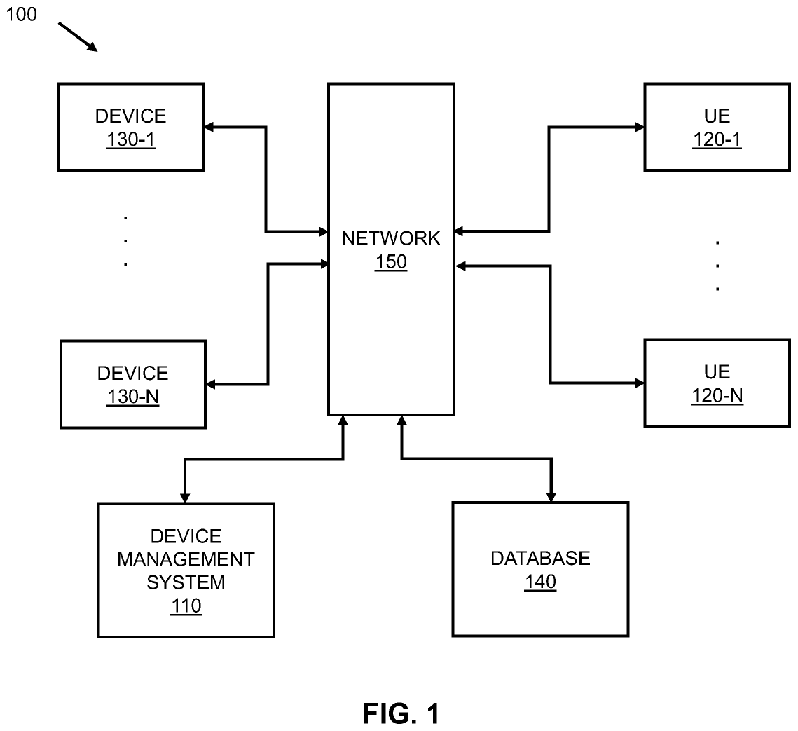

FIG. 1 illustrates a block diagram of an example system architecture 100 for managing one or more updates of one or more devices in a vehicle system, according to one or more embodiments. As illustrated in FIG. 1, the system architecture 100 may include a device management system 110, a plurality of user equipment (UEs) 120-1 to 120-N, a plurality of devices 130-1, a database 140, and a network 150.

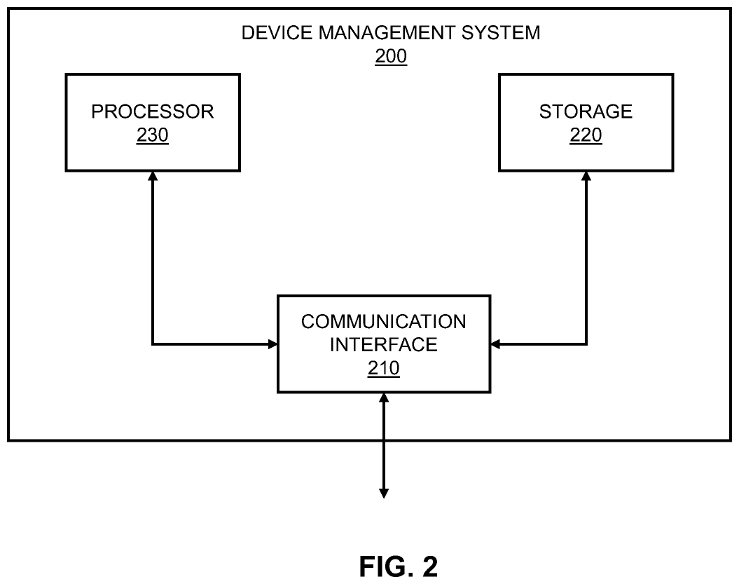

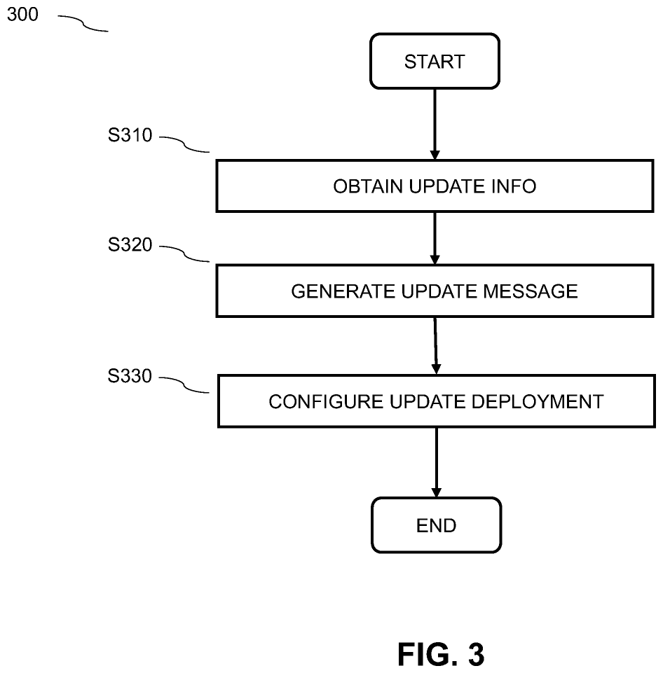

In general, the device management system 110 may be communicatively coupled to the plurality of UEs 120-1 to 120-N and the database 140 via the network 150, and may be configured to interoperate with said UEs and database so as to manage one or more updates for the plurality of devices 130-1 to 130-N. Components which may be included in the device management system 110 are described below with reference to FIG. 2, and operations which may be performed by the device management system 110 are described below with reference to FIG. 3.

The plurality of UEs 120-1 to 120-N may include one or more systems, devices, and any other suitable equipment which may be utilized by one or more users associated with one or more of the devices 130-1 to 130-N. The one or more users may include, but are not limited to, a software developer for developing software/firmware associated with one or more of the devices 130-1 to 130-N, a manager of one or more of the devices 130-1 to 130-N, a vehicle manufacturer/device vendor of one or more the devices 130-1 to 130-N, a driver/user of one or more the devices 130-1 to 130-N, and the like. The one or more users may be located at different geographical locations.

The plurality of UEs 130-1 to 130-N may be utilized by one or more associated users to access and to utilize the device management system 110. Specifically, the user(s) may access, via the associated UE, the device management system 110 to manage one or more device updates. For instance, the user(s) may utilize, via the associated UE, the device management system 110 to search for one or more available device updates, to schedule one or more device updates, to configure one or more device updates, to execute deployment of one or more device updates, to publish one or more device updates, and the like. Further, the user(s) may also utilize the device management system 110 to obtain (e.g., view, download, etc.) information associated with the one or more device updates (e.g., content of the device updates, type of device updates, creator of the device updates, etc.).

According to one or more example embodiments, one or more of the plurality of UEs 120-1 to 120-N may include a computing device (e.g., a desktop computer, a laptop computer, a tablet computer, a handheld computer, a smart speaker, a server, etc.), a mobile device (e.g., a smart phone, etc.), a wearable device (e.g., a pair of smart glasses or a smart watch), a SIM-based device, or any other suitable device which may be associated with the one or more users. Further, the plurality of UEs 120-1 to 120-N may include, for example, a work station, a testing system, a software development system, and the like.

According to one or more example embodiments, at least a portion of the plurality of UEs 120-1 to 120-N may be located at different geographical locations. For instance, a first portion of the plurality of UEs 120-1 to 120-N may be utilized by a first user (e.g., a developer of a software update for a first device, etc.) and the first user and the associated UE(s) may be located at a first location, while a second portion of the plurality of UEs 120-1 to 120-N may be utilized by a second user (e.g., a manager of the first device, etc.) and the second user and the associated UE(s) may be located at a second location different from the first location.

According to one or more example embodiments, the devices 130-1 to 130-N may include one or more remote devices associated with the vehicle systems. In this regard, the remote devices described herein may refer to electronic components, subsystems, and/or modules that are interconnected (e.g., via network 150) and capable of communication with one or more systems (e.g., device management system 110) and one or more equipment (e.g., UE 120-1 to 120-N, database 140, etc.). These devices can include, but are not limited to:
Devices associated with control units in the vehicle, such as electronic control units (ECUs), transmission control units (TCUs), body control module (BCM) units, and the like;
Devices of vehicle infotainment systems and features, such as audio/video entertainment system, navigation system, connectivity features, user interfaces, and the like;
Telematics devices, such as components responsible for communication and remote monitoring of the vehicle, enabling services like remote diagnostics, vehicle tracking, and emergency assistance.
Sensor devices, such as devices that collect data from various sensors, such as those related to ADAS (Advanced Driver Assistance Systems) or environmental monitoring.

Additionally or alternatively, the devices 130-1 to 130-N may include other types of devices within the vehicle system that require update management. Each of these devices may have implanted or embedded therein a software or a firmware which, when being executed by the device, performing one or more associated operations.

Further, one or more of the devices 130-1 to 130-N may be one or more remote devices which may be located at geographical locations different from the device management system 110, from one or more of the plurality of UEs 120-1 to 120-N, and/or from the database 140. These remote devices may be interconnected with the device management system 110, the database 140, and/or the plurality of UEs 120-1 to 120-N via the network 150, and the software/firmware associated therewith may be updated remotely by the device management system 110 via utilizing Over-the-Air (OTA) update capabilities. Similarly, at least a portion of the devices 130-1 to 130-N may be located at geographical locations different from another portion of the devices 130-1 to 130-N.

Referring still to FIG. 1, the database 140 may include a server, a repository, or any suitable equipment which may be configured to store data or information associated with device updates. According to embodiments, the database 140 may leverage indexing and querying functionalities of database (e.g., PostgreSQL, etc.) in storing and provisioning of the device updates. Accordingly, the database 140 may efficiently manage and retrieve device updates (and/or data and information associated therewith) based on various criteria, such as device model, software version, schedule, planned release date, device location, and the like.

The network 150 may include one or more wired and/or wireless networks, which may be configured to couple the device management system 110, the plurality of UEs 120-1 to 120-N, the plurality of devices 130-1 to 130-N, and the database 140 to one another.

For example, the network 150 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

According to one or more example embodiments, the network 150 may include a virtual network, which may include one or more physical network components (e.g., Ethernet, WiFi module, telecommunication network hardware, etc.) with one or more virtualized network functions (e.g., a control area network (CAN) bus, etc.) implemented therein.

According to one or more example embodiments, the network 150 may be utilized by the device management system 110 to OTA device updates in one or more of the devices 130-1 to 130-N. In this way, the OTA communication between the device management system 110 and the devices 130-1 to 130-N enable efficient and secure device updates, thereby enable the device management system 110 to securely and reliably manage and distribute device updates in the form of data packages, while enabling the devices to receive timely updates.

It can be understood that the components included in the system architecture 100, and the configuration thereof, described above with reference to FIG. 1 are merely example embodiments, and the system architecture may include more or less components than as described, and/or the components included therein may be arranged in any a manner different from as described, without departing from the scope of the present disclosure.

For instance, according to one or more example embodiments, the system architecture 100 may include one or more proxy servers interconnecting the devices 130-1 to 130-N to the device management system 110 via the network 150, one or more network load balancer interconnecting the devices 130-1 to 130-N to the one or more proxy servers, and the like, so as to manage the incoming and/or outgoing network traffics and provide functionalities such as load balancing, routing, security, and observability. Further, the system architecture 100 may also include one or more virtual private networks (VPNs) interconnecting the UEs 120-1 to 120-N to the device management system 110.

Referring next to FIG. 2, which illustrates a block diagram of example components of a device management system 200, according to one or more embodiments. The device management system 200 may be similar to device management system 110 in FIG. 1.

As illustrated in FIG. 2, the device management system 200 may include at least one communication interface 210, at least one storage 220, and at least one processor 230. According to embodiments, device management system 200 (or one or more components included therein) may be deployed in a server (e.g., a cloud server, a hybrid cloud server, a server cluster, etc.)

The communication interface 210 may include a transceiver-like component (e.g., a transceiver, a separate receiver and transmitter, a bus, etc.) that enables the device management system 200 (or one or more components included therein) to communicate with one or more components external to the device management system 200, such as via a wired connection, a wireless connection, or a combination of wired and wireless connections.

For instance, the communication interface 210 may couple the device management system 200 (or one or more components included therein) to a plurality of UEs (e.g., UE 120-1 to 120-N in FIG. 1, etc.), to a plurality of devices (e.g., devices 130-1 to 130-N in FIG. 1, etc.), and/or to a database (e.g., database 140 in FIG. 1, etc.) to thereby enable them to communicate and to interoperate with each. As another example, the communication interface 210 may enable the components of the device management system 200 to communicate with each other. For instance, the communication interface 210 may couple the storage 220 to the processor 230 to thereby enable them to communicate and to interoperate with each other.

The communication interface 210 may include a hardware-based interface, such as a bus interface, an Ethernet interface, an optical interface, a coaxial interface, an infrared interface, a radio frequency (RF) interface, a universal serial bus (USB) interface, a Wi-Fi interface, a cellular network interface, a software interface, or the like. According to embodiments, communication interface 210 may include at least one controller area network (CAN) bus configurable to communicatively couple the components of the device management system 200 (e.g., storage 220, processor 230, etc.) to a plurality of UEs (e.g., UE 120-1 to 120-N), to a plurality of devices (e.g., devices 130-1 to 130-N), and/or to the database 140. Additionally or alternatively, the communication interface 210 may include a software-based interface, such as an application programming interface (API), a virtualized network interface (e.g., virtualized CAN bus, etc.), or the like.

The communication interface 210 may be configured to receive information from one or more components external to the device management system 200 and to provide the same to the processor 230 for further processing and/or to the storage 220 for storing. For instance, the communication interface 210 may receive, from the plurality of UEs, one or more user inputs for managing one or more device updates (e.g., viewing available updates, viewing information of devices, scheduling deployment of a device update, triggering development of a device update, configure or modify a device update, etc.), and may provide the same to the processor 230 and/or the storage 220. Similarly, the communication interface 210 may be configured to enable the processor 230 of the device management system 200 to provide one or more information to one or more components external to the device management system 200.

Referring still to FIG. 2, the at least one storage 220 may include one or more storage mediums suitable for storing data, information, and/or computer-readable/computer-executable instructions therein. According to embodiments, the storage 220 may include a random access memory (RAM), a read only memory (ROM), and/or another type of dynamic or static storage device (e.g., a flash memory, a magnetic memory, and/or an optical memory) that stores information and/or instructions for use by the processor 230.

Additionally or alternatively, the storage 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The storage 220 may be configured to store information to-be utilized by the processor 230 for performing one or more operations to manage one or more updates for one or more devices. For instance, the storage 220 may be configured to store one or more device update deployment settings provided by one or more users, to store information associated with one or more users associated with the devices and/or with the development of the updates, to store information of one or more devices, to store device updates received from the database, and the like.

The at least one processor 230 may be configured to receive (e.g., via the communication interface 210, etc.) one or more signals defining one or more instructions for performing one or more operations. Further, the processor 230 may be implemented in hardware, firmware, or a combination of hardware and software. The processor 230 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

The at least one processor 230 may include one or more processors capable of being programmed to perform a function or an operation for managing one or more device updates. For instance, the processor 230 may be configured to execute computer-readable instructions stored in a memory storage (e.g., storage 220, etc.) to thereby perform one or more actions or one or more operations described herein.

It can be understood that the components included in the device management system 200, and the configuration thereof, described above with reference to FIG. 2 are merely example embodiments, and the device management system 200 may include more or less components than as described, and/or the components included therein may be arranged in any a manner different from as described, without departing from the scope of the present disclosure.

For instance, according to one or more example embodiments, the device management system 200 may include an input module (e.g., a touch screen display, a button, a switch, a microphone, a sensor, a keyboard, a mouse, a joystick, a keypad, soft keys, etc.) and/or an output module (e.g., a display, a speaker, a ringer, one or more light-emitting diodes (LEDs), a LED-based display such as an active-matrix organic light-emitting diode (AMOLED) display, a thin-film transistor (TFT) display, a liquid crystal display, etc.), which may be configured to receive one or more user inputs from one or more users and/or output information to the one or more users.

Referring next to FIG. 3, which illustrates a flow diagram of an example method 300 for managing one or more updates for one or more devices in a vehicle system, according to one or more embodiments. One or more operations of method 300 may be performed by at least one processor (e.g., processor 230, etc.) of the device management system, upon executing computer-executable instructions stored in at least one storage medium (e.g., storage 220, etc.).

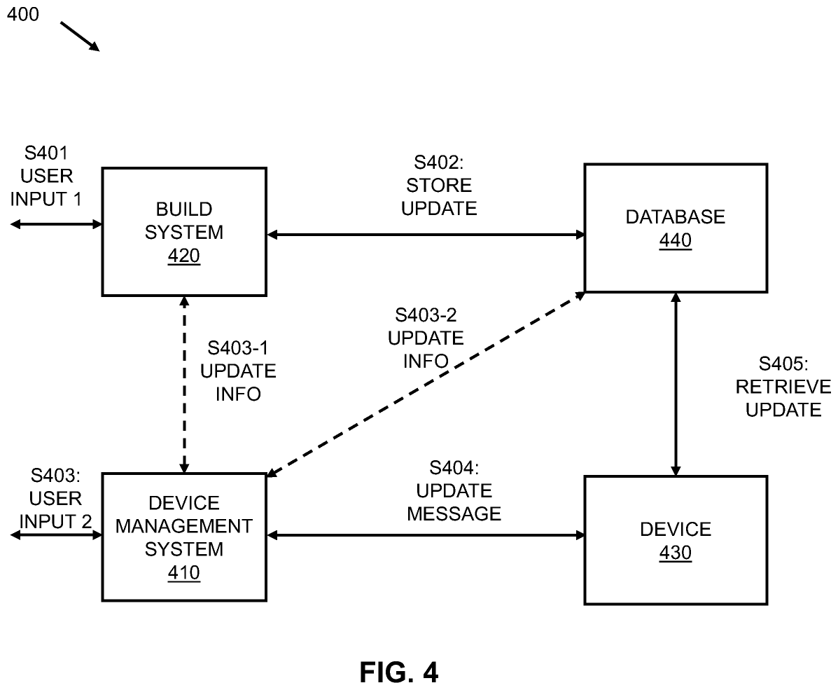

As illustrated in FIG. 3, at operation S310, the at least one processor of the device management system may be configured to obtain information associated with one or more device updates (may be referred to as “update information” herein). According of embodiments, the at least one processor may obtain the update information from a user. Alternatively or additionally, the at least one processor may obtain the update information from a database and/or from a build system. Descriptions of an example use case in which the update information is received are provided below with reference to example use case in FIG. 4.

Upon obtaining the update information, the method 300 may proceed to operation S320, at which the at least one processor of the device management system may be configured to generate, based on the obtained update information, one or more messages associated with the update (may be referred to as “update message” herein). For instance, the at least one processor may determine, based on the obtained update information, a type of the update (e.g., temporary update, compulsory update, optional update, etc.), a criticality of the update (e.g., urgent update, non-urgent update, update associated with safety feature, etc.), and the like. Accordingly, the at least one processor may generate the update message based on determined information. The update message may include information of the update, such as device identification, type of update (e.g., temporary update, non-temporary update, etc.), criticality/urgency of the update, update version, deployment schedule, the storage information of the update, and the like.

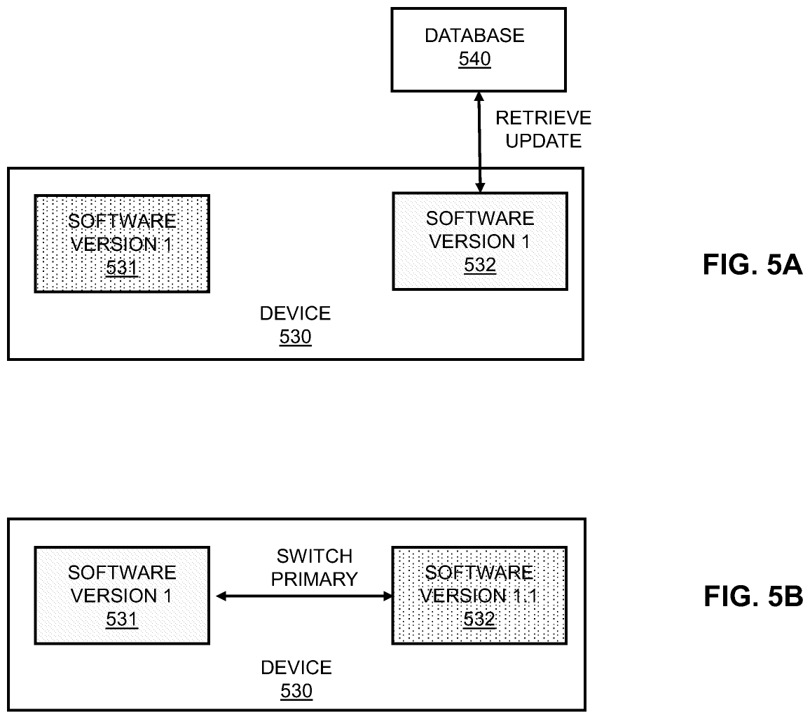

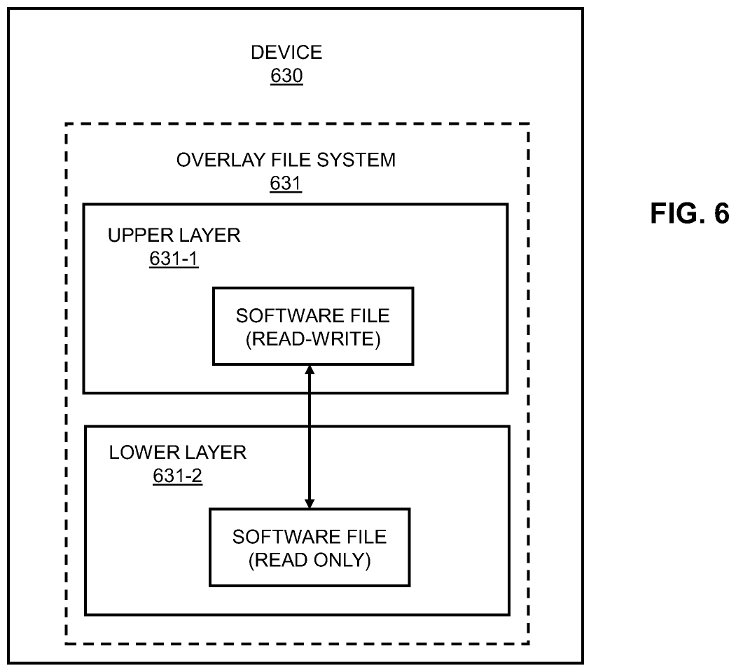

Accordingly, at operation S330, the at least one processor may configure the deployment of the update. For instance, the at least one processor may provide the update message to the device to-be updated (may be referred to as “target device” herein) to thereby instruct the target device to configure the update deployment. According to embodiments, the at least one processor may be configured to generate and provide the update message to the target device to cause the target device to configure a non-temporary update (descriptions of example use case associated therewith are provide below with reference to FIG. 5A to FIG. 5B). According to embodiments, the at least one processor may be configured to generate and provide the update message to the target device to cause the target device to configure a temporary update (descriptions of example use case associated therewith are provided below with reference to FIG. 6).

Referring next to FIG. 4, which illustrates a block diagram of an example system configuration 400 for providing update delivery, according to one or more embodiments. As illustrated in FIG. 4, the system configuration 400 may include a device management system 410, a build system 420, a device 430, and a database 440. The device management system 410, and the database 440 may be similar those described herein with reference to other Figures, the build system 420 may be similar to a UE described herein with reference to other Figures, and the device 430 may be similar to a target device described herein with reference to other Figures. Further, one or more operations in FIG. 4 may be similar to one or more operations in method 300 of FIG. 3.

In the example of FIG. 4, a first user (e.g., a software developer, etc.) may utilize the build system 420 to create or build an update for the device 430 (at operation S401). Upon building or creating the device update, the build system 420 may be configured to provide (e.g., via network 150, etc.) the update to the database 440, and the database 440 may be configured to store the device update therein (at operation S402).

Accordingly, a second user (e.g., a manager of the device 430, etc.) may access the device management system 410 (e.g., via an associated UE, directly access without utilizing UE, etc.) to manage the device update, such as to schedule deployment of the device update, to execute the deployment of the device update, and the like (at operation S403). At this operation, the deice management system 410 (or at least one processor included therein) may receive the update information from the second user. In this regard, the device management system 410 may be configured to generate and output one or more graphical user interfaces (GUIs) and output the one or more GUIs to the second user (via an input/output module). Accordingly, the device management system 410 may receive the user input from the second user by determining the user interactions with the one or more GUIs.

Additionally or alternatively, the device management system 410 may obtain or receive the update information from the build system 240 (at optional operation S403-1), and/or may obtain or receive the update information from the database 440 (at optional operation S403-2).

Upon obtaining the update information, the device management system 410 (or the at least one processor included therein) may be configured to generate one or more update messages based on the update information. Accordingly, the update message may be provided to the device 430 (at operation S404). One or more operations performed by the device management system, such as the receiving of update information and/or the provisioning of update message may be performed via OTA.

Upon receiving the update message from the device management system 410, the device 430 may be configured to retrieve or obtain, based on the update message, the device update from the database 440 (at operation S405). Accordingly, the device 430 may configure the deployment of the device update based on the retrieved device update and the update message. Descriptions of example uses cases of the device configuring the deployment of the device update are provided in the following with reference to FIG. 5A to FIG. 6.

Referring first to FIG. 5A, which illustrates a block diagram of a first configuration of an example use case for deploying a device update, according to one or more embodiments. In the example of FIG. 5A, it is assumed that the device 530 (which may be similar to the device 430 in FIG. 4) has received an update message from a device management system (e.g., device management 410 in FIG. 4), and has determined that the type of update is a non-temporary update (e.g., an essential update, an optional update, etc.)

As illustrated in FIG. 5A, the device 530 may include a first portion 531 and a second portion 532, and each of the first portion 531 and the second portion 532 may have a software of a first version (illustrated as “software version 1” in FIG. 5A). In this regard, one of the portions 531 and 532 may be configured to store a primary software which the device executes, and another one of the portions 531 and 532 may be configured to store a cloned version of the software for backup, redundancy, or any other suitable purpose. According to embodiments, the software may include an operational system (OS) image.

In this regard, the device 530 may determine a required device update based on the update message, and may retrieve the update from the database 540 (which may be similar to the database 440 in FIG. 4). By way of example, assuming that the update message indicates that the update is a non-temporary update for updating the software from “version 1” to “version 1.1”, the device 530 may retrieve the update (e.g., software version 1.1) from the database 540, and may deploy the update accordingly. For instance, the device may overwrite or replace the software in one of the first partition 531 and the second partition 532 with the software obtained from the database 540.

Referring next to FIG. 5B, which illustrates a block diagram of a second configuration of the example use case for deploying the device update, according to one or more embodiments. The components in FIG. 5B may be similar to those described above with reference to FIG. 5A.

In the example of FIG. 5B, it is assumed that the device 530 has obtained the device update “software version 1.1” and has overwrote or replaced the software in the second partition 532 (illustrated as “software version 1” in FIG. 5A). Subsequently, the device may switch the primary software from the software in the first partition 531 (e.g., “software version 1”) to the updated software in the second partition 532 (e.g., “software version 1.1”). Next, the device 530 may reboot or restart so as to switch the running software to the new primary software.

It can be understood that the device 530 may be configured to deploy the non-temporary device update in any other suitable manner, and/or to deploy any other type of non-temporary device update in the similar manner, without departing from the scope of the present disclosure.

Referring to FIG. 6, which illustrates a block diagram of a configuration of an example use case for deploying a temporary device update, according to one or more embodiments. In the example of FIG. 6, it is assumed that the device 630 (which may be similar to the device 430 in FIG. 4) has received an update message from a device management system (e.g., device management 410 in FIG. 4), has determined that the type of update is a temporary update (e.g., an update of Beta version of a software, a temporary hotfix, an update for testing purpose, etc.), and has obtained the device update from a database (e.g., database 430 in FIG. 4, etc.).

As illustrated in FIG. 6, device 6530 may include an overlay file system 631 which include an upper layer 631-1 and a lower layer 631-2. Said layers 631-1 and 631-2 may be included in one or more of the first portion 531 and the second portion 532. Further, each of the layers 631-1 and 631-2 may include the same software file, wherein the upper layer 631-1 and/or the software file included therein may be temporary created by the device 630 based on the lower layer 631-2 and the software file include therein.

Specifically, based on determining, from an update message provided by the device management system, that the update is a temporary update, the device 630 may create a reference or pointer to the software file in the lower layer 631-2, allowing the device 630 to continue to execute the software file in the lower layer 631-2 for normal operation without interruption.

Subsequently, the device 630 may then initiates the creation of a temporary copy of the software file and include the copied software file into the upper layer 631-1, where the temporary update will be applied. Accordingly, the temporary update is perform in the upper layer 631-1, ensuring that the original software file in the lower layer 631-2 remains intact and uninterrupted during the temporary update process. According to embodiments, the device 630 may be configured to remove the software file in the upper layer 631-1 after a period of time (e.g., after a predetermined amount of time specified in the update message, after the device 630 is rebooted, etc.), such that the device 630 may return to the last known state.

In view of the above, the software file in the upper layer 631-1 may be referred to as “Read-Write File”, while the software file in the lower layer 631-2 may be referred to as “Read-Only File”. According to embodiments, the device 630 may utilize Copy on Write (CoW) mechanisms in managing the overlay file system 631. Accordingly, the temporary update process may become more efficient and resource-friendly, ensuring minimal disruption to the normal operation of the device 630. Further, reversible updates may be provided, thereby minimize the risk of potential issues such as state drifting of the device 630.

To this end, example embodiments of the present disclosure provide a device management system (and a method for utilizing the same) which enable effective and efficient management of one or more updates of one or more devices in a vehicle system, which in turn addresses the problems in the related art as described above.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method for managing an update of a device in a vehicle system, the method being implemented by at least one processor of a system and comprising:
obtaining information associated with the update;
generating a message including information of the update; and
configuring deployment of the update,
wherein the update comprises one of: a temporary update and a non-temporary update.

2. The method according to claim 1, wherein the obtaining the information associated with the update comprises:
obtaining the information from at least one of: a user equipment, a build system, and a database.

3. The method according to claim 1, wherein the configuring the deployment of the update comprises:
providing the message to the device via Over-the-Air (OTA) communication to cause the device to configure the deployment of the update based on the message.

4. The method according to claim 1, wherein the device is a remote device located at a geographical location different from the system.

5. The method according to claim 1, wherein the update is created by a first user located at a first geographical location, wherein the information associated with the update is obtained from a second user located at a second geographical location, and wherein the first geographical location is different from the second geographical location.

6. The method according to claim 3, wherein the update is a temporary update on a software file in the device, wherein the device comprises a lower layer including the software file, and wherein the configuring the deployment of the update comprises:
providing the message to the device to cause the device to:
obtain an updated software file from a database;
create an upper layer comprises a software file based on the lower layer and the software file included therein;
replace the software file in the upper layer with the updated software file; and
remove the updated software file in the upper layer after a period of

7. The method according to claim 6, wherein the software file comprises an operating system (OS) file.

8. The method according to claim 3, wherein the update is a non-temporary update on the software file in the device, wherein the device comprises a first partition and a second partition, wherein the first partition and the second partition comprises the software file, and wherein the configuring the deployment of the update comprises:
providing the message to the device to cause the device to:
obtain an updated software file from a database;
replace the software file in one of the first partition and the second partition with the updated software file;
configure the partition with the updated software file as primary partition; and
reboot the device to execute the updated software file as primary software.

9. A system for managing an update of a device in a vehicle system, the system comprising:
a memory storage storing computer-executable instructions; and
at least one processor communicatively coupled to the memory storage, wherein the at least one processor is configured to execute the instructions to:
obtain information associated with the update;
generate a message including information of the update; and
configure deployment of the update,
wherein the update comprises one of: a temporary update and a non-temporary update.

10. The system according to claim 9, wherein the at least one processor is configured to execute the instructions to obtain the information associated with the update by:
obtaining the information from at least one of: a user equipment, a build system, and a database.

11. The system according to claim 9, wherein the at least one processor is configured to execute the instructions to configure the deployment of the update by:
providing the message to the device via Over-the-Air (OTA) communication to cause the device to configure the deployment of the update based on the message.

12. The system according to claim 9, wherein the device is a remote device located at a geographical location different from the system.

13. The system according to claim 9, wherein the update is created by a first user located at a first geographical location, wherein the information associated with the update is obtained from a second user located at a second geographical location, and wherein the first geographical location is different from the second geographical location.

14. The system according to claim 11, wherein the update is a temporary update on a software file in the device, wherein the device comprises a lower layer including the software file, and wherein the at least one processor is configured to execute the instructions to configure the deployment of the update by:
providing the message to the device to cause the device to:
obtain an updated software file from a database;
create an upper layer comprises a software file based on the lower layer and the software file included therein;
replace the software file in the upper layer with the updated software file; and
remove the updated software file in the upper layer after a period of

15. The system according to claim 14, wherein the software file comprises an operating system (OS) file.

16. The system according to claim 11, wherein the update is a non-temporary update on the software file in the device, wherein the device comprises a first partition and a second partition, wherein the first partition and the second partition comprises the software file, and wherein the at least one processor is configured to execute the instructions to configure the deployment of the update by:
providing the message to the device to cause the device to:
obtain an updated software file from a database;
replace the software file in one of the first partition and the second partition with the updated software file;
configure the partition with the updated software file as primary partition; and
reboot the device to execute the updated software file as primary software.

17. A non-transitory computer-readable recording medium having recorded thereon instructions executable by at least one processor of a system to cause the processor to perform a method for managing an update of a device in a vehicle system including:
obtaining information associated with the update;
generating a message including information of the update; and
configuring deployment of the update,
wherein the update comprises one of: a temporary update and a non-temporary update.

18. The non-transitory computer-readable recording medium according to claim 17, wherein the obtaining the information associated with the update comprises:
obtaining the information from at least one of: a user equipment, a build system, and a database.

19. The non-transitory computer-readable recording medium according to claim 17, wherein the configuring the deployment of the update comprises:
providing the message to the device via Over-the-Air (OTA) communication to cause the device to configure the deployment of the update based on the message.

20. The non-transitory computer-readable recording medium to claim 17, wherein the device is a remote device located at a geographical location different from the system.
